(19) United States
(12) Patent Application Publication
(10) Pub. No.: US 2012/0148483 A1
(43) Pub. Date: Jun. 14, 2012

(54) MACROCYCLE MODIFIED AG NANOPARTICULATE CATALYSTS WITH VARIABLE OXYGEN REDUCTION ACTIVITY IN ALKALINE MEDIA

(76) Inventors: Rongrong Chen, Fishers, IN (US); Junsong Guo, Indianapolis, IN (US)

(21) Appl. No.: 13/196,452

(22) Filed: Aug. 2, 2011

Related U.S. Application Data
(60) Provisional application No. 61/369,891, filed on Aug. 2, 2010.
(60) Provisional application No. 61/418,060, filed on Nov. 30, 2010.

(51) Int. Cl. C01B 15/01; B01J 31/34; B01J 31/32; B01J 31/26; B01J 31/28; B82Y 30/00

(52) U.S. Cl. 423/584; 502/171; 502/163; 502/167; 977/773; 977/742; 977/734; 977/762

(57) ABSTRACT

A composition for catalyzing oxygen reduction reactions in alkaline media, including transition-metal macrocycles and metallic nano-particles. The metallic nanoparticles have diameters ranging from about 1 nm to about 500 nm and are typically selected from the group including Ag, Ni, Co, Au, W, Mo, Mn and combinations thereof.

### CROSS-REFERENCE TO RELATED APPLICATIONS

This patent application claims priority to co-pending U.S. provisional patent application Ser. No. 61/369,891, filed on Aug. 2, 2010, and to co-pending U.S. provisional patent application Ser. No. 61/418,060, filed on Nov. 30, 2010.

### ACKNOWLEDGEMENT

Research leading to this novel technology was federally supported by grant no. W911NF-07-2-0036 from the United States Army Research Laboratory. The government retains certain rights in this novel technology.

### TECHNICAL FIELD

The novel technology relates generally to the field of electrochemistry, and, more particularly, to cobalt phthalocyanine and/or N4 macrocycle promoted Ag-based nano-metallic oxidation reduction reaction (ORR) catalysts.

### BACKGROUND

Fuel cells, among other devices, typically employ a catalyst system for the oxygen electrode or air electrode to catalyze the ORR of the electrochemical device in alkaline media. Electrochemical devices include metal-air or sugar-air cells or batteries, and fuel cells such as H₂/O₂ fuel cells or direct alcohol fuel cells. Compared with the Pt-based catalysts for the ORR in the state-of-the-art proton exchange membrane fuel cells, non-Pt catalysts, including Ag, Au, Pd, Ni, manganese oxide, prophyrins, and phthalocyanines, are active and affordable for the ORR in alkaline media. Among these catalysts, the relatively inexpensive and abundant Ag is a top candidate to replace Pt for the ORR in alkaline media due to its relative high activity for the ORR through an approximated 4-electron pathway.

However, the ORR operation potential on Ag-based catalysts is still more than 100 mV lower than that on Pt-based catalysts, and the stability of Ag or Ag-based catalysts for the ORR is also a big concern. To develop non-Pt electrocatalysts with ORR activity and stability to be comparable with that of Pt-based catalysts is highly desirable for commercializing solid alkaline fuel cells, alkaline fuel cells or metal-air batteries. Thus, there remains a need to catalyst system that utilize more abundant and less expensive materials to yield an ORR operation potential comparable to that of Pt-based catalysts. The present invention addresses this need.

### SUMMARY

The present novel technology relates to hybrid electrocatalytic systems including metallic nanoparticles incorporating transition-metal macrocycles exterior coatings or sheathes for catalyzing oxygen reduction reaction (ORR) in alkaline media, such as Ag nanoparticles modified with a Co-based phthalocyanine surface treatment, for oxygen reduction reaction (ORR) in alkaline media.

One object of the present novel technology is to provide an improved catalyst for oxygen reduction reactions. Related objects and advantages of the present novel technology will be apparent from the following description.

### BRIEF DESCRIPTION OF THE DRAWINGS

FIG. 1A graphically illustrates the molecular structure of CoPc.

FIG. 1B graphically illustrates the molecular structure of CoPcF₁₆.

FIG. 1C graphically illustrates the Mulliken charge of FIG. 1A.

FIG. 1D graphically illustrates the Mulliken charge of FIG. 1B.

FIG. 2A shows the XPS narrow scan spectra of Co2p_{3/2} core level for Ag/C, CoPc@Ag/C, CoPcF₁₆@Ag/C, CoPc/C and CoPcF₁₆/C catalysts.

FIG. 2B shows the XPS narrow scan spectra of Ag3d_{5/2} for Ag/C, CoPc@Ag/C, and CoPcF₁₆@Ag/C catalysts.

FIG. 3 shows the ORR polarization curves obtained on CoPc/C, CoPcF₁₆/C, Ag/C, CoPc@Ag/C, CoPcF₁₆@Ag/C and Pt/C (50 wt. %,) with a rotation rate at 2500 rpm in 0.1 M NaOH solutions saturated with oxygen.

FIG. 4 presents the mass-corrected Tafel plots of log Iₖ (mA cm⁻²) vs. the electrode potential E (vs. Hg/HgO) for the ORR on the electrodes prepared with various catalysts in an O₂-saturated 0.1 M NaOH solution.

FIG. 5 graphically illustrates current density vs. potential for CoPc/C, CoPcF₁₆/C, Ag/C, CoPc@Ag/C, CoPcF₁₆@Ag/C, and Pt/C, respectively.

FIG. 6A graphically illustrates a comparison of cyclic voltammetris of different catalysts in Ar-purged 0.1 M NaOH solution at 5^{th} cycle, CoPc and CoPcF₁₆.

FIG. 6B graphically illustrates a comparison of cyclic voltammetris of different catalysts in Ar-purged 0.1 M NaOH solution at 5^{th} cycle, Ag/C, CoPc@Ag/C and CoPcF₁₆@Ag/C.

FIG. 6C graphically illustrates a comparison of cyclic voltammetris at first cycle at CoPc@Ag/C and CoPcF₁₆@Ag/C.

FIG. 7A-7F graphically illustrate the oxygen reduction polarization curves at 400, 900, 1600 and 2500 rpm in O₂-purged 0.1 M NaOH.

FIG. 8 graphically illustrates Levich plots of O₂ reduction on Ag/C, CoPc@Ag/C, CoPcF₁₆@Ag/C, CoPc/C, CoPcF₁₆/C and Pt/C catalysts.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

The development of anion exchange membrane fuel cells (AEMFCs) has driven renewed interest in catalysts utilizing oxygen reduction reactions (ORRs) in alkaline media. Compared to proton exchange membrane fuel cells (PEMFCs), one of the advantages of the AEMFCs or alkaline fuel cells (AFCs) is the possibility of using other catalyst materials instead of the standard platinum or carbon-supported Pt electrocatalysts for the ORR. Several non-Pt catalysts, including Ag, Au, Pd, cobalt and manganese oxide, prophyrins, and phthalocyanines, have been well studied. Among various catalyst systems, the relatively inexpensive and abundant Ag is an economically advantageous choice to replace Pt as the cathode catalyst for applying in AEMFCs. In addition to cost advantages, Ag has a relative high electrocatalytic activity for reducing O₂ via an approximated 4-electron ORR pathway. However, the ORR kinetics on Ag nano-particles in alkaline media are problematic, as ORR overpotentials on Ag catalysts are more than 100 mV higher than that on Pt catalysts under the same conditions.

Adsorbed coordination compounds on metallic substrates show promise with respect to the controlled functionalization of surfaces on the nanoscale. Planar metal complexes such as M(II)-porphyrins (MP) and M(II)-phthalocyanines (MPc) are particularly interesting due to their physical and chemical properties. The metal centers of MP or MPc molecules typically possess no axial ligands and represent coordinatively unsaturated sites with potential catalytic functionality. For example, CoPc and FePc molecules are well known to have desirable electrocatalytic activities for reducing O₂ molecules. Electronic and geometric properties of Co-tetraphenyl-porphyrin (CoTPP) layers on Ag(111) have been investigated using photoelectron diffraction (PED), near-edge x-ray absorption fine-structure (NEXAFS) measurements and discrete Fourier transform (DFT) calculations, revealing that the central Co atom of the Co-TPP resides predominantly above fcc and hcp hollow sites of the Ag (111) substrate and that the interaction of the CoTPP with the Ag(111) substrate can induce modifications of the CoTPP molecular configuration, such as a distorted macrocycle with a shifted position of the Co metal center. Similarly, the interaction of a number of phthalocyanine molecules (SnPc, PbPc, and CoPc) with the Ag(111) surface has been investigated. Each of the phthalocyanine molecules (SnPc, PbPc and CoPc) has been found to donate charge to the silver surface, and that back donation from Ag to the metal atom Co, Sn, or Pb is only significant for CoPc. The adsorbed MP or MPcs molecules were found to induce a local restructuring process of the metallic Ag substrate, which could alter Ag's functionality and the morphology of the adsorbed MP or MPc molecules.

The present novel technology relates to hybrid catalysts, specifically hybrid electrocatalytic systems 100 incorporating metal chelate compounds or transition-metal macrocycles 105 with metallic or metal oxide nano-particles 110 for catalyzing oxygen reduction reaction (ORR) in alkaline media. The ORR catalytic activity and stability of the hybrid catalysts 100 combining transition-metal macrocycles 105 with metallic nano-particles 110 are significantly improved over the ORR catalytic activity and stability of either the transition-metal macrocycles 105 or the nano-sized metallic catalysts 110, and is comparable to the ORR catalytic activity and stability of traditional, and significantly more expensive, catalytic systems such as carbon supported Pt (Pt/C). For example, integration of Co-macrocycles 105 with Ag or Ag-based nanoparticles 110 (typically about 1 nm to about 1000 nm) yields a high performance and stable hybrid catalytic system for the ORR in alkaline media. The Co-macrocycles 105 may include Co-phthalocyanines (CoPc), cobalt(II)1,2,3,4,8,9,10,11,15,16,17,18,22,23,24,25-hexadecafluoro-29H,31H-phthalocyanine (CoPc F₁₆), Co-tetramethoxyphenylporphirine (CoTMPP), and other Co-organic molecules containing Co—N2 or Co—N4 structures and the like.

The transition-metal macro cycles 105 are typically large organic molecules containing transition-metals (Co, Fe, Mn, Ni, and the like), which are typically bonded with two or four nitrogen atoms. The large organic molecules are typically selected to be phthalocyanine, porphyrin, derives thereof, or the like. Metallic nanoparticles include Ag/Ag-based, Co/Co-based and other metal/metal-based particles. Metals in metallic nanoparticles 110 may be in various forms, such as metallic, alloyed with other metals, metal oxide, and etc. The metallic nanoparticles may include Ag, Pt, Pd, Ni, Co, Au, W, Mo, Mn, Fe, Ir, Sn, Cu, Zn, Os, Rh, Ru, Ti, V, Cr, Zr, Mo, their oxides, and combinations thereof. The particle size of metallic nanoparticles 110 is typically in the range of about 0.1 nm to about 5000 nm, more typically from about 1 nm to about 1000 nm. Metallic nanoparticles 110 may be supported on carbon, unsupported, or mixed with carbon or other electrically conducting or semiconducting material. Typical support structures include carbon black, carbon nanotubes, carbon nanofibers, fullerenes, and other carbon materials with different morphologies, or electrically conducting polypyrrole and its derivates, nickel powder, and the like.

Macrocycles 105 can be physically mixed with carbon-supported or non-carbon supported metallic nanoparticles 110, or adsorbed physically or chemically on carbon-supported or non-carbon supported metallic nanoparticle 110 surfaces to form a hybrid catalyst system 100. By incorporating transition-metal macrocycles 105 onto metallic nano-particles 110, physical and electrochemical properties of the surface of nano-metallic catalysts 100 can be modified significantly. For example, coating Co-phthalocyanines (CoPc) 105 on carbon supported Ag or AgCo nano-particles 110 modifies both the electronic properties and geometrical structures of both metallic surfaces and CoPc surface, yielding improved oxygen and/or water adsorption and reducing OH⁻ adsorption. Therefore, improved ORR activity and stability on the invented hybrid CoPc+Ag/Ag-based catalysts 100 are achieved.

By combining electrochemical measurements with theoretical DFT calculations, key factors that control ORR activity and stability on CoPc and FePc model electrodes may be better understood. Adsorption energy of O₂, OH⁻ and HOOH on CoPc or FePc molecules plays a key role to determine the ORR activity and stability. DFT simulation and electrochemical measurement results suggest that the ORR on fully halogenated CoPcF₁₆ has more favorable O₂ reduction potentials than on CoPc due to the fluorine substitution, impacting the molecular electron affinity. The electronic and geometric properties of the metal centers (Co or Fe) of the adsorbed molecules 105 can be co-determined by the underlying substrate atoms 110.

ORR activities on carbon supported Ag nano-particles 110 modified with CoPc or CoPcF₁₆ molecules 105 (CoPc@Ag/C and CoPcF₁₆@Ag/C). CoPc@Ag/C or CoPcF₁₆@Ag/C catalysts 100 have more favorable O₂ reduction potentials and rate constants than CoPc/C (and the CoPcF₁₆/C) catalysts or Ag/C catalysts. The ORR activity of the Ag nano-catalysts 100 is variable or tunable by adjusting the compositions of the adsorbed organic molecules. A new class of “hybrid” catalysts 100 based on the adsorption of organic molecules 110 on metallic nano-particles 105 for meeting performance and durability requirements in fuel cell applications is thus developed.

### Example 1

Sixty weight percent Ag loadings 110 on carbon black were prepared by a citrate-protecting method. CoPc or CoPcF₁₆-modified Ag/C catalyst 110 were prepared by mixing 15 weight percent CoPc or 15 weight percent CoPcF₁₆ with 85 weight percent (60 weight percent Ag/C) uniformly in ethanol by ultrasonic stirring, which were denoted as CoPc@Ag/C and CoPcF₁₆@Ag/C respectively. The CoPc@Ag/C and CoPcF₁₆@Ag/C samples could also be prepared by adsorbing CoPc directly onto the Ag/C electrodes from a DMF solution containing 10⁻⁵M CoPc. The geometrical and electronic structures of CoPc and CoPcF₁₆ molecules were calculated using DFT. Composition and electrochemical properties of the catalysts 100 were characterized by x-ray photoelectron spectroscopy (XPS), cyclic voltammetry (CV), rotating ring disk electrode (RRDE) and oxygen electrode tests.

### Example 2

A cathode for catalyzing ORRs in alkaline media may be produced comprising metal chelate compounds 105 and metallic and/or oxide nanoparticles 110. Likewise, the same materials may be used to produce an anode for catalyzing hydrogen, hydrazine, alcohol, and/or glucose oxidation reactions in alkaline media. The metallic nanoparticles 110 may be selected from the group including Ag, Pt, Pd, Ni, Co, Au, W, Mo, Mn, Fe, Ir, Sn, Cu, Zn, Os, Rh, Ru, Ti, V, Cr, Zr, Mo, their oxides, and combinations thereof. The metal chelate 105 may be selected from the group including Co, Fe, Ni, Mn, Zn, Cr, Cu, and/or Sn phthalocyanines, porphyrins, and their derivatives, with or without heat treatment and in concentrations of from about 1 ppm to about 80 weight percent of the catalyst material. The transition-metal macrocycles 105 and nanoparticles 110 may or may not be dispersed in carbon and/or metal oxide supports for electronic conductivity, catalyst distribution, and stability purposes. Likewise, anodes and cathodes prepared as described above may be used in the production of anion exchange membrane fuel cells or metal-air batteries.

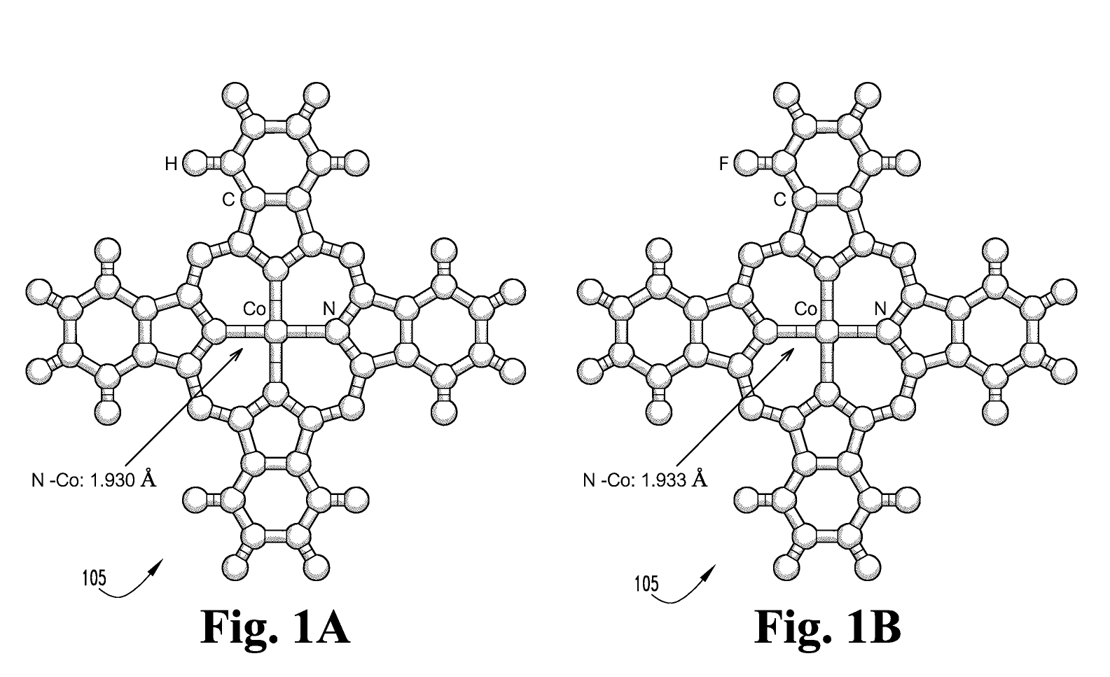

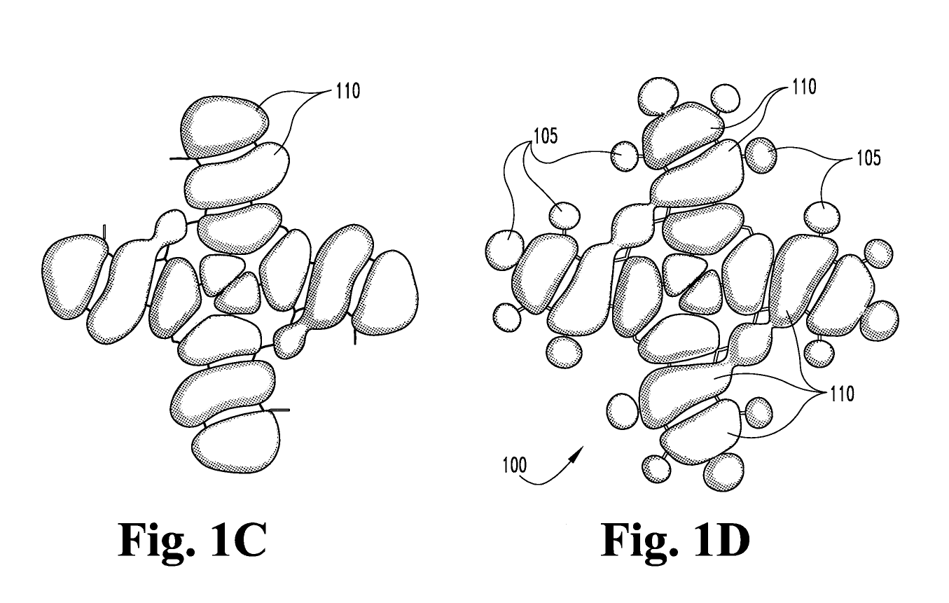

FIG. 1 shows the DFT optimized CoPc and CoPcF₁₆ molecular structures, which are planar 4-fold symmetrical aromatic macrocyclic organic molecule. When the peripherical hydrogen atoms of the benzene rings of the CoPc (FIG. 1A) are substituted with fluorine atoms of the CoPcF₁₆ (FIG. 1B), the Co—N bond distance is increased, and the charges on the central Co become increasingly positive. Using DFT, the adsorption energy of O₂ on the CoPcF₁₆ is calculated as 0.467 eV, which is 0.065 eV higher than that on the CoPc molecule. Higher O₂ adsorption energy results more positive ORR onset and half-wave potentials. Fluorine atoms induce a higher electron affinity to the entire CoPc molecule, consequently leading to a much more reactive system.

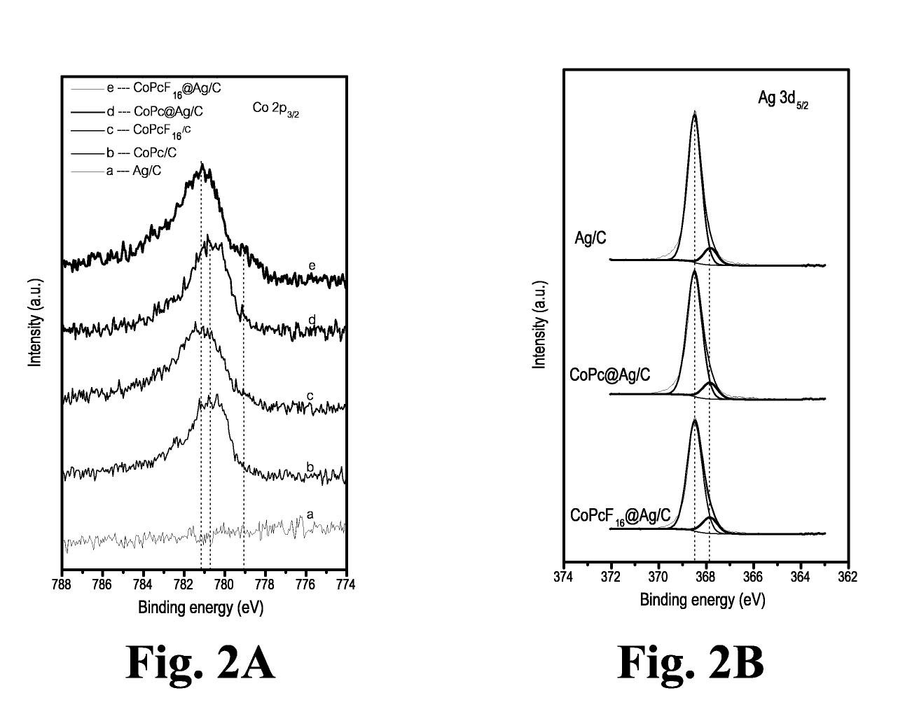

FIG. 2A illustrates the XPS narrow scan spectra of Co2p_{3/2} core level for Ag/C, CoPc@Ag/C, CoPcF₁₆@Ag/C, CoPc/C and CoPcF₁₆/C catalysts. A peak at 780.9 eV for CoPc/C and at 781.4 eV for CoPcF₁₆/C was observed and can be attributed to Co²⁺. The binding energy of Co2p_{3/2} was positively shifted 0.5 eV for the CoPcF₁₆ catalyst, which agrees with the DFT calculation results (FIGS. 1C and 1D). More positive charges on the central Co of CoPcF₁₆ tend to increase the Co²⁺ peak energy in the XPS. For the CoPc@Ag/C and CoPcF₁₆@Ag/C, the peak positions of Co2p_{3/2} of Co²⁺ do not shift compared those observed for the CoPc/C and the CoPcF₁₆/C catalysts. However, another new peak at 779.3 eV appears clearly for the CoPc@Ag/C and the CoPcF₁₆@Ag/C catalysts, which is attributed to Co2p_{3/2} of Co⁰ and indicates that the electronic properties of the metal centers (Co) of the adsorbed CoPc or CoPcF₁₆ molecules are affected by the underlying Ag substrate atoms. From the XPS narrow scan spectral of Ag3d_{5/2} in FIG. 2B, two peaks located at 368.8 and 368.1 eV are distinguished by de-convolution, which are attributed to Ag3d_{5/2} of Ag⁰ and Ag⁺ respectively. The observed binding energy shift of the 3d peak toward the negative direction for Ag metal versus Ag₂O agrees well with what was reported. The contents of Ag₂O on silver surface are calculated from the areas of two peaks at 368.8 and 368.1 eV, which are 10.36%, 11.56% and 12.78% for Ag/C, CoPc@Ag/C and CoPcF₁₆@Ag/C, respectively. The XPS results imply that electron transfer occurs between Ag and Co²⁺ in CoPc@Ag/C and CoPcF₁₆@Ag/C catalysts, which are likely due to back electron donation from Ag to the Co metal atom. The electron transfer between the adsorbed organic molecules and the Ag substrate can be tuned by changing the ligand groups of the adsorbed molecules.

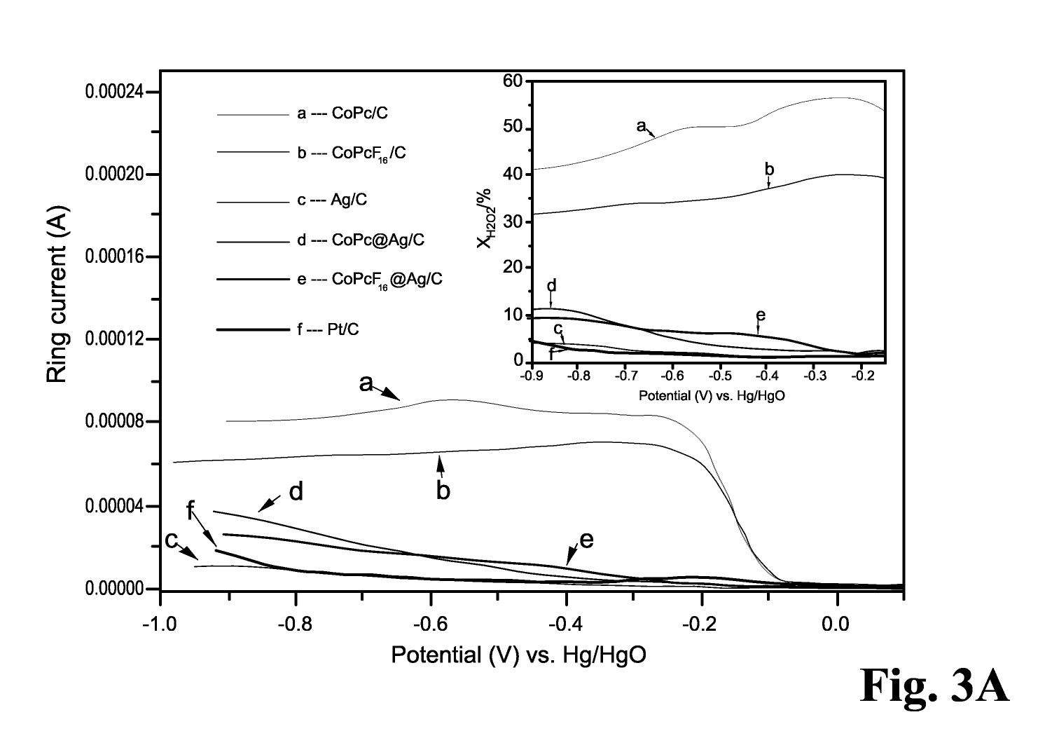

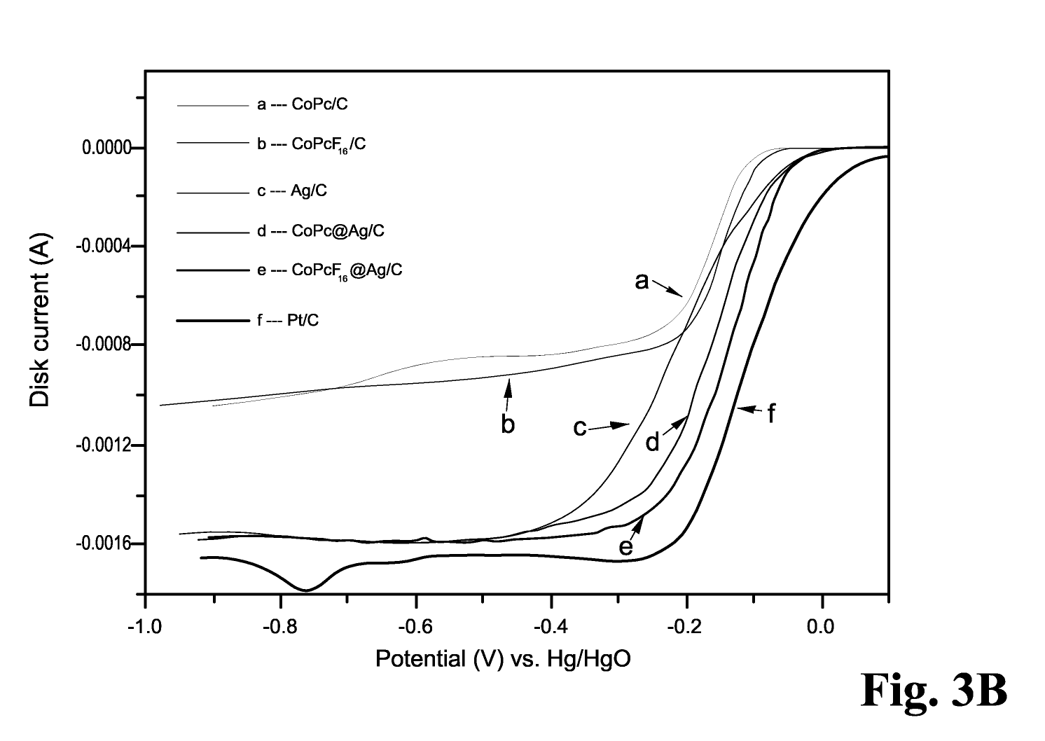

FIG. 3 shows the ORR polarization curves obtained on CoPc/C, CoPcF₁₆/C, Ag/C, CoPc@Ag/C, CoPcF₁₆@Ag/C and Pt/C (50 wt. %,) with a rotation rate at 2500 rpm in 0.1 M NaOH solutions saturated with oxygen. The half-wave potential, E_{1/2} (the potential corresponding to 50% of the peak current) for CoPc@Ag/C or CoPcF₁₆@Ag/C is 50 mV-80 mV more positive compared to the E_{1/2} observed for the Ag/C. Ag-nanoparticles modified with CoPc or CoPcF₁₆ macromolecules thus more actively interact with O₂ than do the Ag/C catalysts. The effect for shifting the E_{1/2} to the positive direction by the adsorbed CoPcF₁₆ molecules on the Ag/C catalysts is more significant than the CoPc molecules. By further precisely varying the geometry and electronic structures of the adsorbed Co-macrocyclic molecules on the Ag-nano particle surfaces, additional improvement to the E_{1/2} is anticipated.

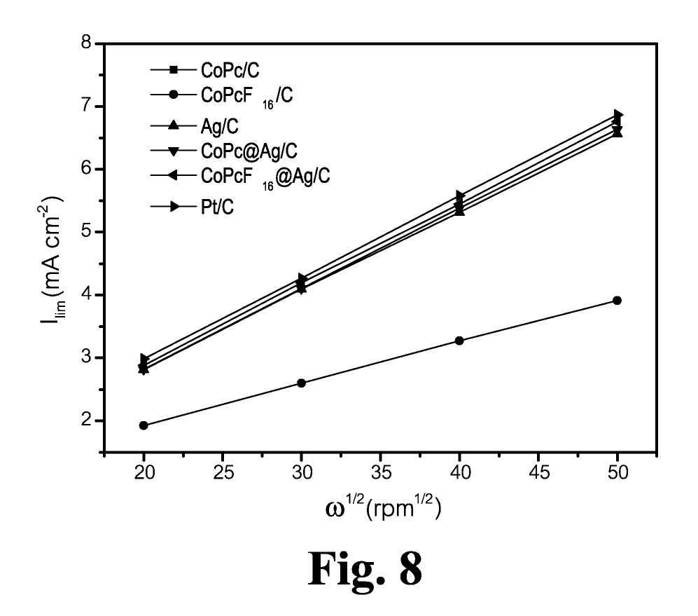

While the half-wave potential for the ORR on the CoPc@Ag/C or CoPcF₁₆@Ag/C catalysts is 50-80 mV more favorable than that on CoPc/C, CoPcF₁₆/C or Ag/C catalysts, the observed limiting currents on the CoPc@Ag/C or CoPcF₁₆@Ag/C catalysts are as high as what is observed on the Ag/C catalyst, and almost twice higher than that of CoPc/C and CoPcF₁₆/C catalysts (FIG. 3). The electrochemical reduction of O₂ is a multi-electron reaction that has two main pathways. The first involves the transfer of 2-electrons to produce H₂O₂, while the second involves a direct 4-electron pathway to produce water. The limiting currents at different rotation rates can be used to construct the Levich plots (FIG. 8). The number of electron transferred for the ORR on Ag/C, CoPc@Ag/C, CoPcF₁₆@Ag/C, CoPc/C and CoPcF₁₆/C catalysts are calculated as 3.85, 3.93, 3.97, 2.07 and 2.05 respectively. Although the ORR on either the CoPc/C or the CoPcF₁₆/C catalysts are mainly through a 2-electron pathway, both the CoPc@Ag/C and the CoPcF₁₆@Ag/C catalysts show a close 4 electron transfer, which is comparable to that on the Ag/C catalysts that carry the ORR via a 4-electron pathway in alkaline solutions.

By using the rotating ring disk electrode (RRDE) measurements, the formation of H₂O₂ during the ORR process can be monitored and the ORR pathways on the electrodes prepared with various catalysts can be verified. The inset of FIG. 3 gives the H₂O₂ yields on six catalyst specimens. On both Ag/C and Pt/C electrodes, no significant solution phase H₂O₂ was detected and thus the H₂O₂ yield was negligible, which supports a direct 4-electron pathway to produce water. For the CoPc/C and the CoPcF₁₆/C electrodes, a significant ring current was detected starting at the ORR onset potential of the disk electrode and up to 50% and 30% of the H₂O₂ yield was measured on the CoPc and the CoPcF₁₆ electrode, respectively. This indicates that H₂O₂ is a main product for the ORR catalyzed by the CoPc/C or the CoPcF₁₆/C catalysts. For the CoPc@Ag/C and the CoPcF₁₆@Ag/C catalysts, the disk limiting currents are as high as that on the Ag/C catalyst, but the ring currents are slightly higher than that on the Ag/C catalyst and much lower than those on the CoPc/C and the CoPcF₁₆/C catalysts. The observed ring currents on either the CoPc@Ag/C or the CoPcF₁₆@Ag/C catalysts are likely due to the non-optimized preparation method, such that CoPc or CoPcF₁₆ molecules are not fully adsorbed on the silver surfaces and the ORR could carry out on the CoPc/C or the CoPcF₁₆/C catalysts to produce H₂O₂ as the final product. However, less than 10% of the H₂O₂ yields are observed to be at potentials lower than −0.5V vs. Hg/HgO for either the CoPc@Ag/C or the CoPcF₁₆@Ag/C catalysts, which indicates that the ORRs occur mainly on the CoPc or CoPcF₁₆ modified Ag nano-particle surfaces. These RRDE results also confirm the results calculated from the Levich equation that the ORR electron exchange number is close to 4 electrons for the ORR on the Ag/C, the CoPc@Ag/C or the CoPcF₁₆@Ag/C catalysts, but about 2 electrons for the ORR on the CoPc/C or the CoPcF₁₆/C.

FIG. 4 illustrates mass-corrected Tafel plots of log Iₖ (mA cm⁻²) vs. the electrode potential E (vs. Hg/HgO) for the ORR on the electrodes prepared with various catalysts in an O₂-saturated 0.1 M NaOH solution. These Tafel curves were obtained from the polarization curves of FIG. 3 with a rotation rate of 2500 rpm. The Tafel plot slopes (listed in Table 1) at the lower overpotential region (where E>0 V vs. Hg/HgO) for Pt/C and Ag/C catalysts are 58 and 59 mV dec⁻¹ respectively, which close to 60 mV dec⁻¹ and indicate that the first electron transfer is the rate-determining step at the low overpotentials.

TABLE 1
Electrochemical parameters for the oxygen reduction
estimated from polarization curves

| | | | Tafel plot slopes | |
|---|---|---|---|---|
| | | Iₗᵢₘ/mA | (mV dec⁻¹) | |
| Electrode | E_{1/2}/V | (@ 0.5 V, 2500) | Low η | High η |
| CoPc/C | −0.168 | 0.87 | N/A | 78 |
| CoPcF₁₆/C | −0.152 | 0.93 | N/A | 70 |
| Ag/C | −0.214 | 1.56 | 59 | 133 |
| CoPc@Ag/C | −0.164 | 1.58 | 55 | 101 |
| CoPcF₁₆@Ag/C | −0.132 | 1.61 | 55 | 95 |
| Pt/C | −0.109 | 1.63 | 58 | 116 |

At the higher overpotential region (where E<−100 mV vs. Hg/HgO), the Tafel slope for Ag/C is 133 mV dec⁻¹, which is much higher than that of Pt/C (116 mV dec⁻¹) and accounts for the lower activity of Ag/C catalysts. After modification of Ag/C catalysts with either the CoPc or the CoPcF₁₆ molecules, the Tafel slopes for the CoPc@Ag/C and the CoPcF₁₆@Ag/C catalysts at the higher overpotential region drop significantly to 101 and 95 mV dec⁻¹ respectively. At an alkaline fuel cell cathode working potential(−0.100 V vs Hg/HgO, equivalent to an overpotential of 0.320V), the ORR kinetic current on the CoPc@Ag/C and the CoPcF₁₆@Ag/C is 1.46 mA cm⁻² and 2.73 mA cm⁻², which is about 3.2 times higher than that of the Ag/C electrode (0.85 mA cm⁻²). In a pure oxygen and 0.1 M NaOH electrolyte environment, the CoPc@Ag/C and the CoPcF₁₆@Ag/C catalysts display better performance than the Ag/C and the CoPc/C or the CoPcF₁₆/C catalysts, and are much close to that of Pt/C catalysts.

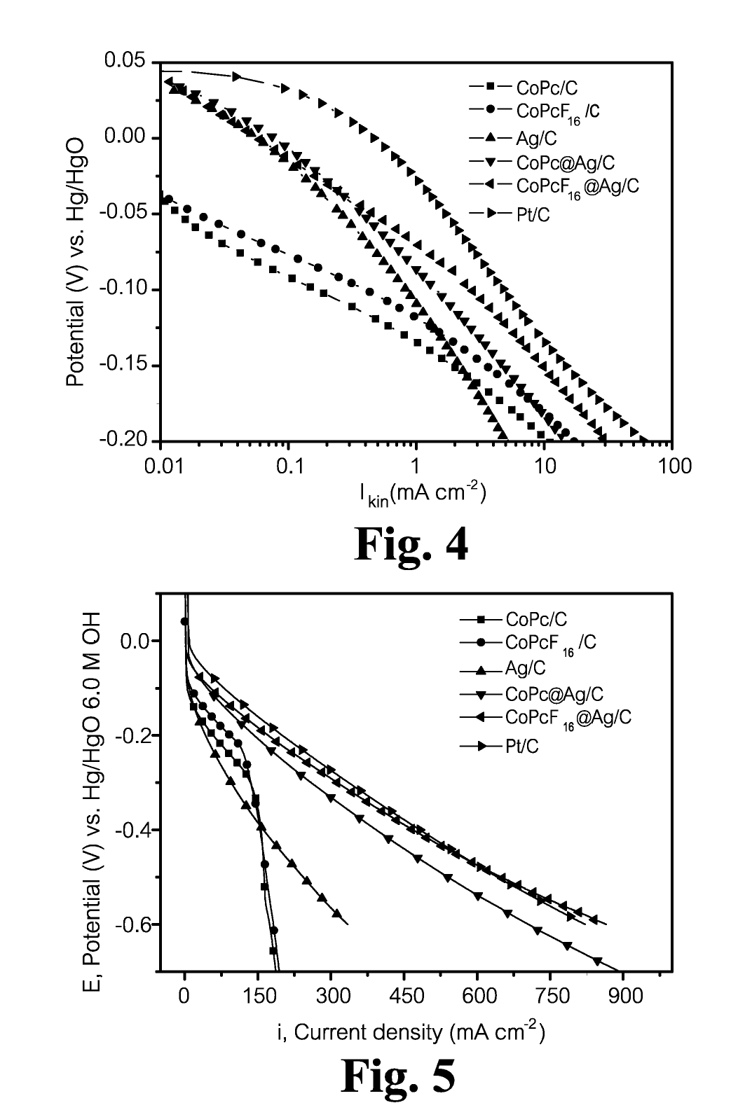

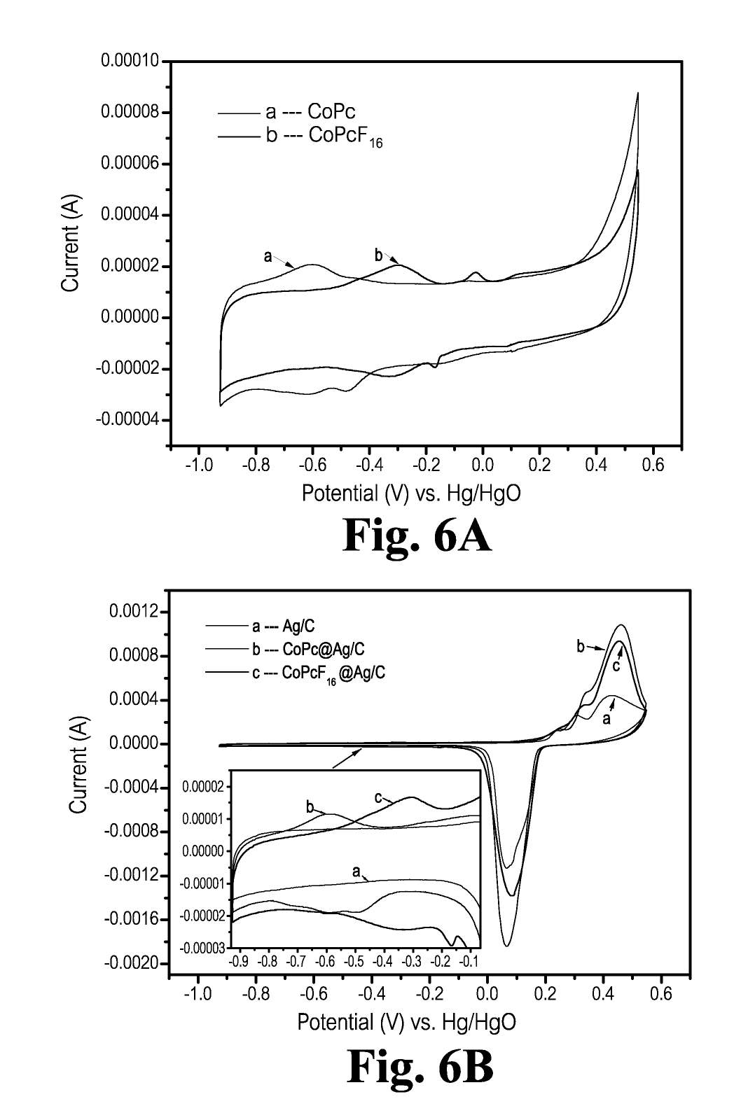

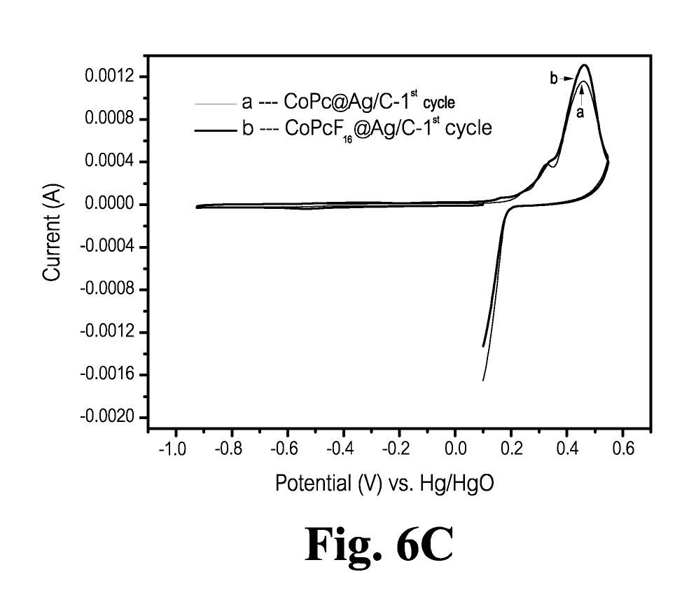

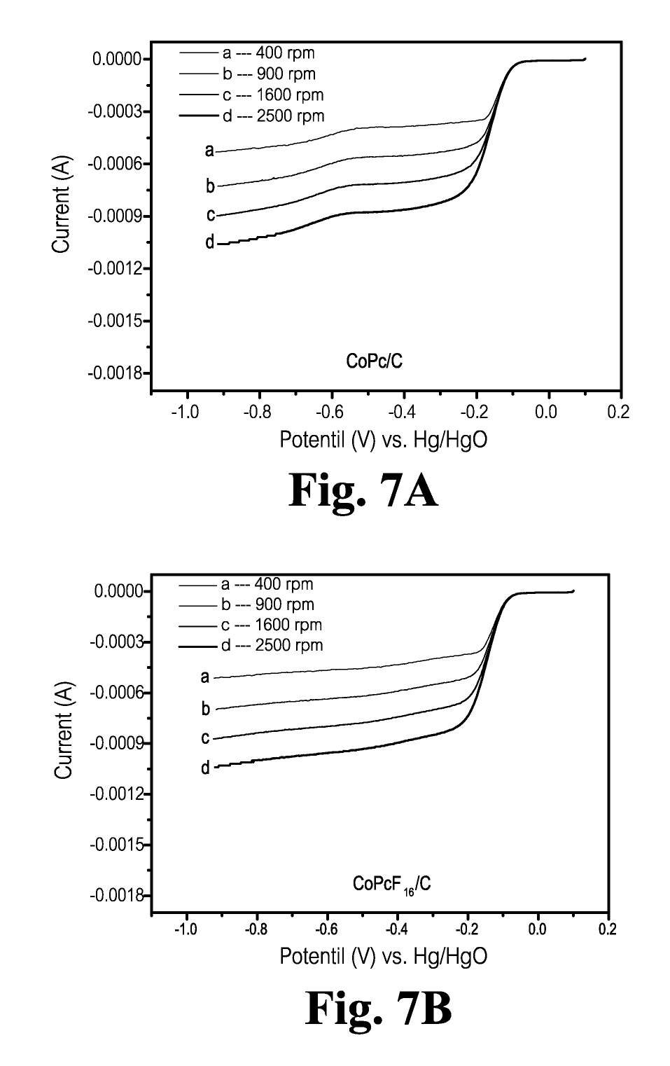

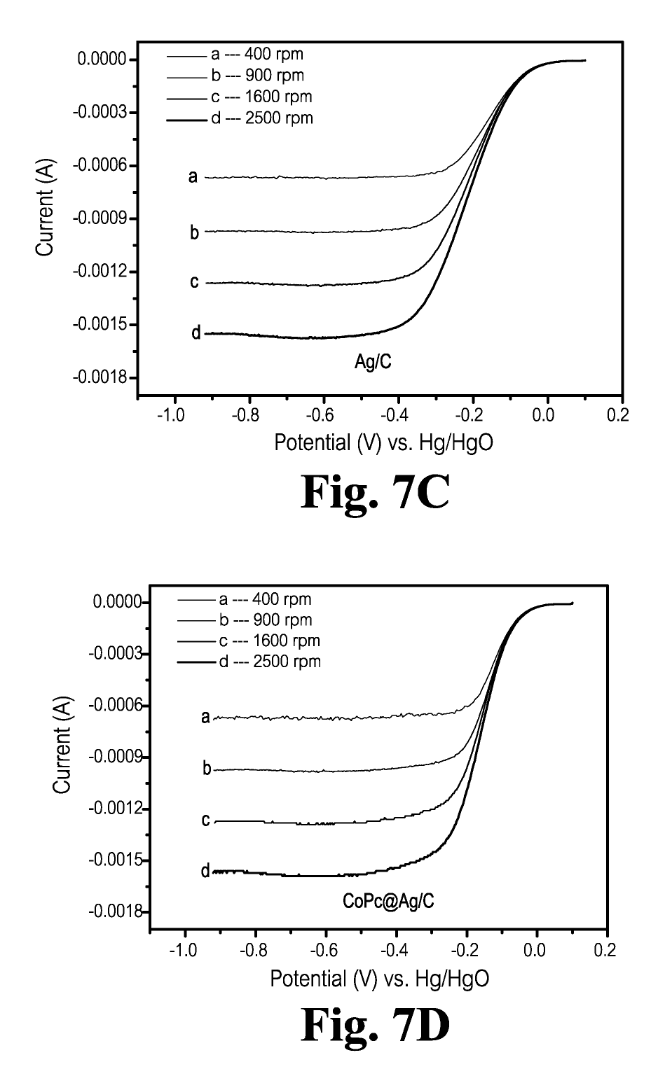

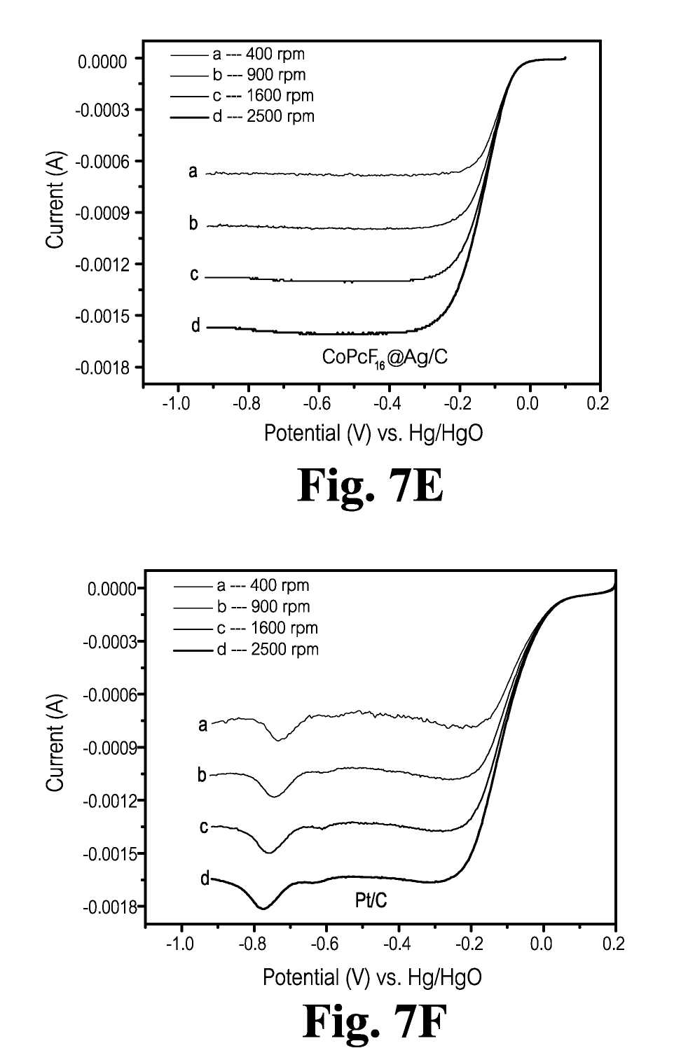

The performance of the oxygen cathode prepared with various catalysts was tested in a cell in an oxygen saturated 6.0 M NaOH solution as the electrolyte. The i-E curves were recorded point-by-point with increasing current. The performance of the oxygen cathode was highly dependent on the catalyst used. FIG. 5 shows the polarization curves for oxygen reduction on the Ag/C, CoPc/C, CoPcF₁₆/C, CoPc@Ag/C, CoPcF₁₆@Ag/C and Pt/C cathodes. The polarization of the CoPc@Ag/C and the CoPcF₁₆@Ag/C cathode is significant lower than Ag/C, CoPc/C and CoPcF₁₆/C electrodes in both low current density and high current density regions. At the high current density region, the polarization of the CoPcF₁₆@Ag/C electrode is almost the same as what was observed on the Pt/C electrode, which improved significantly by comparing with the Ag/C, CoPc/C or CoPcF₁₆/C electrodes. The performance of oxygen electrodes with Ag/C, CoPc/C, CoPcF₁₆/C, CoPc@Ag/C, CoPcF₁₆@Ag/C and Pt/C catalysts are consistent with those obtained by the RRDE measurements. The electrocatalytic activity toward oxygen reduction was demonstrated to be tunable by adsorbing various CoPc or CoPcF₁₆ molecules on Ag nano-particle surfaces.

Other hybrid catalyst systems, including Co—N4 or N2 macrocycles with other forms of nano-sized metals (such as Ag, Ni, Co, Au, W, Mo, Mn) and their based nanoparticles, would likewise be expected to exhibit improved ORR activity and stability.

### Catalysts Preparation

200 mg 60 wt. % silver loadings 110 on carbon black were prepared by a citrate-protecting method as following. 1066.2 mg sodium citric and 666.0 mg NaOH were mixed to prepared 111.0 mL 50 mM sodium citrate solution, and then 111.0 mL 10 mM AgNO₃ was added. 150 mL 7.4 mM NaBH₄ solution was added dropwise under vigorous stirring to obtain a yellowish-brown Ag colloid. 80 mg carbon black was taken to disperse into the above Ag colloid. After the suspension was stirred for 12 hours, the black suspension was filtered, washed and dried, and a 60 wt. Ag/C catalyst sample was obtained. CoPc or CoPcF₁₆-modified Ag/C 110, and carbon supported CoPc or CoPcF₁₆ 105 catalyst were prepared by mixing 15 weight percent cobalt phthalocyanine or 15 weight percent cobalt hexadecafluoro phthalocyanine with 85 weight percent (60% weight percent Ag/C) or 85 weight percent carbon black uniformly in ethanol by ultrasonic stirring. After drying, the obtained samples were denoted as CoPc@Ag/C, CoPcF₁₆@Ag/C, CoPc/C and CoPcF₁₆/C respectively.

### XPS Characterization

X-ray photoelectron spectroscopy (XPS) was recorded by an imaging spectrometer using an Al Kα radiation (1486.6 eV). The binding energies were calibrated relative to C (1s) peak from carbon composition of samples at 284.8 eV.

### Electrochemical Characterization

Electrochemical activities of catalysts were measured by a setup consisting of a computer-controlled potentiostat, a radiometer speed control unit, and a rotating ring disk electrode radiometer (RRDE, glassy carbon with a diameter of 5.5 mm as the disk and with platinum as the ring). Catalyst ink was prepared by ultrasonically mixing 2.0 mg of catalyst samples with 10 uL of the Nafion solution (5%), 1 mL of ethanol and 1 mL of de-ionized water. Then, 40 uL of the prepared catalyst ink was dropped on the surface of the glassy carbon to form a working electrode. The electrochemical measurements were conducted in an argon or oxygen-purged 0.1 M NaOH solution using a standard three-electrode cell with a Pt wire serving as the counter electrode and a Hg/HgO/0.1M OH⁻ electrode used as the reference electrode respectively. H₂O₂ production in O₂-saturated 0.1 M NaOH electrolytes was monitored in a RRDE configuration using a polycrystalline Pt ring biased at 0.3 V vs. Hg/HgO/0.1M OH⁻. The ring current (L_{ring}) was recorded simultaneously with the disk current (I_{disk}). Collection efficiency (N) of the ring electrode was calibrated by K₃Fe(CN)₆ redox reaction in an Ar-saturated 0.1 M NaOH solution. The value of the collection efficiency (N=I_{ring}/I_{disk}) determined is 0.41 for the Pt/C electrode. The fractional yields of H₂O₂ in the ORR were calculated from the RRDE experiments as X_{H2O2}=(2I_{ring}/N)/(I_{disk}+I_{ring}/N).

### Oxygen Electrode Characterization

Catalyst performance of Ag/C, CoPc/C, CoPcF₁₆/C, CoPc@Ag/C, CoPcF₁₆@Ag/C and Pt/C catalysts were further characterized on oxygen electrode in a cell containing 6M NaOH solutions saturated with oxygen. A catalyst ink was prepared by ultrasonically-mixing 3 mg of the catalyst, 200 uL of ethanol and 44.5 uL of Nafion solution (5 wt. %). The ink was pipetted on a 1.61 cm² gas diffusion layer to prepare oxygen electrode. The oxygen electrode was assembled into a cell with 0.71 cm² active surface area in the working electrode. A carbon sheet was used as the counter-electrode, and a Hg/HgO/6.0 M OH⁻ electrode was used as the reference electrode. A 6.0 M NaOH solution was adopted as electrolyte to decrease the influence of IR drop in instead of 0.1M NaOH solution. Polarization curves were recorded galvanostatically with a stepwise increasing current at room temperature.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A composition for catalyzing oxygen reduction reactions in alkaline media, comprising:
a plurality of metallic nanoparticles; and
transition-metal macrocycles operationally connected to the metallic nanoparticles to define catalyst compound particles;
wherein the metallic nanoparticles are generally spherical;
wherein the metallic nanoparticles are substantially between about 1 nanometer and about 1000 nanometers in diameter.

2. The composition of claim 1 wherein the transition-metal macrocycles are selected from the group including Co, Fe, Ni, and Mn phthalocyanines, Co, Fe, Ni, and Mn porphyrins, and derivatives thereof.

3. The composition of claim 1 wherein the metallic nanoparticles are selected from the group including Ag, Ni, Co, Au, W, Mo, Mn and combinations thereof.

4. The composition of claim 1 wherein the metallic nanoparticles have diameters ranging from about 1 nm to about 500 nm.

5. The composition of claim 1 and further comprising carbon support structures connected to respective catalyst compound particles.

6. The composition of claim 5 wherein the carbon support structures are selected from the group including carbon nanotubes, fullerenes, carbon nanofibers, and carbon black.

7. The composition of claim 1 wherein the transition-metal macrocycles are selected from the group including fully halogenated CoPcF₁₆, fully halogenated CoPcCN₁₆, and combinations thereof.

8. A method for catalyzing oxygen reduction reactions in an alkaline environment, comprising:
preparing a combination of Co-based phthalocyanines macrocycles and metallic nano-particles to define a plurality of catalyst composition particles;
enveloping the catalyst composition in an alkaline environment; and
catalyzing an oxygen reaction at the catalyst composition;
wherein the catalyst composition particles are sized between about 1 nanometer and about 500 nanometers.

9. A method for catalyzing oxygen reduction reactions in an alkaline environment, comprising:
defining a catalyst composition as a combination of metallic nanoparticles, wherein each respective particle has a surface treatment of operationally connected transition-metal macrocycles;
enveloping the catalyst composition in an alkaline environment; and
catalyzing an oxygen reduction reaction at the catalyst composition.

10. The method of claim 9 wherein the transition-metal macrocycles are selected from the group including Co, Fe, Ni, and Mn phthalocyanines, Co, Fe, Ni, and Mn porphyrins, and derivatives thereof.

11. The method of claim 9 wherein the metallic nanoparticles are selected from the group including Ag, Ni, Co, Au, W, Mo, Mn and combinations thereof.

12. The method of claim 9 wherein the metallic nanoparticles have diameters ranging from about 1 nm to about 500 nm.

13. A composition for catalyzing oxidation reduction reactions in alkaline media, comprising:
a nanoparticle selected from the group including Ag, Ni, Co, Au, W, Mo, Mn, and combinations thereof; and
a transition-metal macrocycle disposed on the surface of the nanoparticles.

14. The composition of claim 13 wherein the transition-metal macrocycle is selected from the group including Co phthalocyanines, Fe phthalocyanines, Ni phthalocyanines, Mn phthalocyanines, Co porphyrins, Fe porphyrins, Ni porphyrins, Mn porphyrins, and derivatives thereof.

15. The composition of claim 13 and further comprising carbon support structures connected to respective catalyst compound particles.

16. The composition of claim 15 wherein the carbon support structures are selected from the group including carbon nanotubes, fullerenes, carbon nanofibers, and carbon black.
